(19) United States
(12) Patent Application Publication
(10) Pub. No.: US 2010/0129604 A1
(43) Pub. Date: May 27, 2010

(54) COPPER FOIL WITH RESIN LAYER

(76) Inventors: Makoto Uchida, Tokyo (JP); Ryutaro Tanaka, Tokyo (JP); Shigeo Hayashimoto, Tokyo (JP)

Correspondence Address: Nields, Lemack & Frame, LLC, 176 E. Main Street, Suite #5, Westborough, MA, 01581, US

(21) Appl. No.: 12/451,359

(22) PCT Filed: May 13, 2008
(86) PCT No.: PCT/JP2008/058767

§ 371 Date: Feb. 9, 2010

(30) Foreign Application Priority Data
May 17, 2007 (JP) 2007-132160

(51) Int. Cl. B32B 15/088; B32B 15/092; B32B 3/10

(52) U.S. Cl. 428/141; 428/458; 428/418

(57) ABSTRACT

An object of the present invention is to provide a copper foil with a resin layer to be used as a resin substrate for a flexible printed wiring board and having good adhesiveness between the copper foil, to which no roughening treatment is applied, and a raw material resin layer.

A copper foil with a resin layer characterized in that a copper foil having no roughening treatment applied thereto is directly joined to a resin layer, which contains a phenolic hydroxyl group-containing aromatic polyamide resin having a structure represented by the following formula (1):

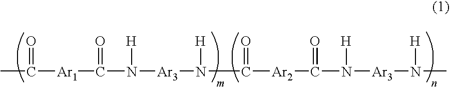

in the formula (1), m and n denote average values and satisfy the relationship:

0.005≦n/(m+n)<0.05,

m+n is 2 to 200; Ar₁ is a divalent aromatic group; Ar₂ is a divalent aromatic group having a phenolic hydroxyl group, and Ar₃ is a divalent aromatic group.

### TECHNICAL FIELD

The present invention relates to a copper foil with a resin layer, useful for a flexible printed wiring board.

### BACKGROUND ART

Usually, as a flexible printed wiring board, a copper-clad laminated board is used, which is formed by bonding a metal foil (mainly, a copper foil) and a polyimide film to each other. Of the copper-clad laminated boards, a copper-clad laminated board called a two-layered CCL is formed by directly bonding a polyimide film and a copper foil to each other with no adhesive layer interposed between them. The two-layered CCL is very useful in view of micro-fabrication of wiring and heat resistance of a substrate; however, adhesive strength between the polyimide film and the copper foil often becomes a problem. As a method of manufacturing a two-layered CCL, for example, a casting method (Patent Document 1) is known in which a two-layered CCL is obtained by applying a polyimide precursor onto a copper foil and heating it. Other than this, a laminate method (Patent Document 2) is known in which a two-layered CCL is obtained by compressing a thermoplastic polyimide film and a copper foil while heating. Alternatively, a plating method is known in which a two-layered CCL is obtained by providing a sputter layer on a polyimide film and plating a copper foil. At present, the casting method is mainly used. The casting method requires a high temperature of 300° C. or more when a polyimide precursor of coating is converted into a polyimide. In addition, shrinkage occurs due to a dehydration reaction. Therefore, it is important to use a high-temperature equipment and technique for suppressing curling.

On the other hand, to the copper foil that has been used for manufacturing a conventional printed wiring board, roughening treatment is applied to form irregularities on one surface, for example, by attaching fine copper particles to the surface, as is disclosed in many documents including Patent Document 1. When such a copper foil is bonded to a base-material resin such as prepreg, the irregularities of the copper foil formed by roughening treatment are embedded within the base-material resin to exert an anchoring effect, thereby ensuring tight adhesion between the copper foil and the base-material resin. However, usually, the surface of the copper foil is coated with a surface preparation agent such as a rust-preventing agent including an amine compound, a long-chain alkyl compound or a silicone compound. Therefore, even if such a surface is directly coated with a polyimide precursor by a casting method to obtain a two-layered CCL, the delamination strength of the copper foil/polyimide resin of the two-layered CCL decreases. On the other hand, if the surface preparation agent is removed from the copper foil surface by performing an intricate step such as a degreasing step or a soft-etching step, the copper foil surface comes to be exposed to air or a polyimide precursor. As a result, corrosion oxidation becomes a problem. Besides this, in a copper foil (untreated copper foil) having a surface treated with none of surface treatments such as a roughening treatment and a rust-preventing treatment, not only adhesive strength but also heat resistance remain unsolved. Improvement of adhesive strength is technically very difficult. Although there is an attempt (Patent Documents 5) to improve heat resistance by using a heat resistant epoxy resin composition as a primer resin, significant improvement is not obtained. Furthermore, when such a heat resistant epoxy resin composition is used as a base-material resin layer, lack of flame resistance becomes a problem.

Patent Document 1: Japanese Patent Publication (KOKOKU) No. 60-042817

Patent Document 2: Japanese Patent Publication (KOKOKU) No. 07-040626

Patent Document 3: Japanese Patent Publication (KOKOKU) No. 06-006360

Patent Document 4: Japanese Patent Publication (KOKOKU) No. 05-022399

Patent Document 5: Japanese Patent Application Laying Open (KOKAI) No. 2003-304068

### DISCLOSURE OF THE INVENTION

If a copper foil having no roughening treatment applied thereto can be used for manufacturing a printed wiring board, the roughening treatment step of the copper foil can be skipped. If so, production cost can be significantly reduced. On the other hand, if the temperature for converting a polyimide precursor into a polyimide can be suppressed to a low level, production cost for producing the resin layer can also be reduced.

Using a copper foil having no roughening treatment applied thereto in a printed wiring board is very useful. This is because the thickness of the printed wiring board is reduced by the level of thickness corresponding to a rough portion, enabling micro-fabrication of a wiring pattern, and because the electric resistance of the wiring surface reduces. If a copper foil having no roughening treatment applied thereto is used for manufacturing a printed wiring board, it is also preferable in view of improving performance.

An object of the present invention is to provide a copper foil with a resin layer to be used as a resin substrate for a flexible printed wiring board and having good adhesiveness between the copper foil and the resin layer without applying roughening treatment to the copper foil.

The present inventors conducted intensive studies with a view toward attaining the object. As a result, the present invention was achieved.

More specifically, the present invention relates to

(1) A copper foil with a resin layer characterized in that a copper foil having no roughening treatment applied thereto is directly joined to a resin layer, which contains a phenolic hydroxyl group-containing aromatic polyamide resin having a structure represented by the following formula (1):

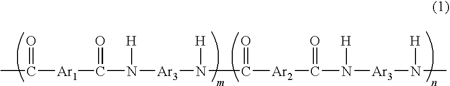

in the formula (1), m and n denote average values and satisfy the relationship:

0.005≦n/(m+n)<0.05,

m+n is 20 to 200; Ar₁ is a divalent aromatic group; Ar₂ is a divalent aromatic group having a phenolic hydroxyl group, and Ar₃ is a divalent aromatic group.
(2) The copper foil with a resin layer according to item (1), wherein the resin layer further contains an aromatic epoxy resin.
(3) The copper foil with a resin layer according to item (1) or (2), wherein the phenolic hydroxyl group-containing aromatic polyamide resin has a structure represented by the following formula (2):

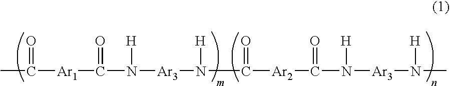

in the formula (2), n and m are defined the same as in the formula (1); x represents the average number of substituents from 1 to 4; and Ar₃ is represented by the following formula (3):

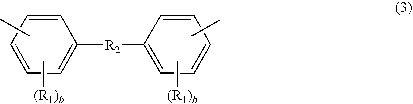

in the formula (3), R₁ is a hydrogen atom or a substituent having 0 to 6 carbon atoms and optionally containing O, S, P, F, and/or Si; R₂ is a direct bond or a bond which has 0 to 6 carbon atoms and may optionally contain O, N, S, P, F, Si; and b is the average number of substituents from 0 to 4.
(4) The copper foil with a resin layer according to any one of items (1) to (3), wherein the surface roughness (Rz) of the copper foil having no roughening treatment applied thereto is 2 μm or less.
(5) A copper foil with a resin layer characterized in that a copper foil having no roughening treatment applied thereto and having a plating layer of one or more types of elements selected from nickel, iron, zinc, gold and tin on a surface thereof is directly joined to a resin layer containing a phenolic hydroxyl group-containing aromatic polyamide resin having a structure represented by the following formula (1):

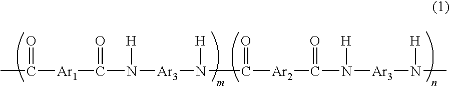

in the formula (1), m and n denote average values and satisfy the relationship:

0.005≦n/(m+n)<0.05,

m+n is 20 to 200; Ar₁ is a divalent aromatic group; Ar₂ is a divalent aromatic group having a phenolic hydroxyl group, and Ar₃ is a divalent aromatic group.
(6) The copper foil with a resin layer according to any one of items (1) to (5), wherein, in the formula (1), Ar₁ is a substituted or unsubstituted phenylene group; Are is a substituted or unsubstituted hydroxyphenylene group; and Ar₃ is an aromatic group formed by two substituted or unsubstituted phenyl groups bonded via —O— or —SO₂—.

Since the resin layer of the copper foil with a resin layer of the present invention contains a phenolic hydroxyl group-containing aromatic polyamide resin, it rarely shrinks when hardening occurs through the reaction with an aromatic epoxy resin. When the resin layer is formed on the copper foil by coating, it exhibits small shrinkage stress and high adhesive strength with the copper foil having no roughening treatment applied thereto. When the copper foil is used as a flexible substrate as it is, hardening can be performed at a low temperature compared to a ring closure reaction of a polyimide precursor. As a result, a processing temperature can be maintained at a low level. Furthermore, the phenolic hydroxyl group-containing aromatic polyamide resin to be used in the present invention is effective as a rust-preventing agent for preventing a copper foil from corrosion. Therefore, the polyamide resin can be used as a primer resin also serving as a rust-preventing agent. Furthermore, if a polyimide precursor solution is applied, dried and heated to convert into polyimide, a copper foil with a polyimide resin layer can be obtained. In this case, the copper foil is heated to a temperature required for the ring-closure reaction of the polyimide precursor. However, since the phenolic hydroxyl group-containing aromatic polyamide resin has high adhesive strength with not only the polyimide precursor but also the polyimide resin, it can be suitably used as an adhesive layer between the copper foil having no roughening treatment applied thereto and the polyimide resin.

As is described above, the copper foil with a resin layer of the present invention is extremely useful, for example in the field of electric materials including an electric substrate.

### BEST MODE FOR CARRYING OUT THE INVENTION

The phenolic hydroxyl group-containing aromatic polyamide resin to be used in the resin layer of the present invention is not particularly limited as long as it has a structure represented by the following formula (1):

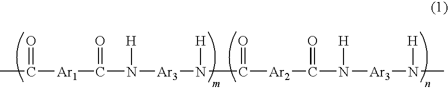

in the formula (1), m and n denote average values and satisfy the relationship:

0.005≦n/(m+n)<0.05,

m+n is 20 to 200; Ar₁ is a divalent aromatic group; Ar₂ is a divalent aromatic group having a phenolic hydroxyl group, and Ar₃ is a divalent aromatic group.

In the formula (1), Ar₁ may be a divalent aromatic group derived from an aromatic compound such as substituted or unsubstituted benzene, biphenyl or naphthalene. Ar₂ may be a divalent aromatic group derived from an aromatic compound having a phenolic hydroxyl group such as substituted or unsubstituted phenol, biphenol or naphthol. Ar₃ may be a divalent aromatic group derived from an aromatic compound such as substituted or unsubstituted benzene, biphenyl or naphthalene, or a divalent aromatic group formed of two substituted or unsubstituted phenyl groups, which are bonded via a bond having 0 to 6 carbon atoms that may contain O, N, S, P, F, Si, and preferably bonded via, —O—, —SO₂—, —CO—, —(CH₂)₁₋₆—, —C(CH₃)₂—, —C(CF₃)₂—.

The phenolic hydroxyl group-containing polyamide resin represented by the formula (1) is preferably a phenolic hydroxyl group-containing aromatic polyamide resin having a structure represented by the following formula (4):

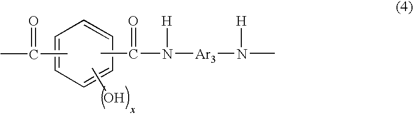

in the formula (4), Ar₃ is the same as the defined in the formula (1); and x is the average number of substituents from 1 to 4.

In particular, the phenolic hydroxyl group-containing polyamide resin represented by the formula (1) is preferably a phenolic hydroxyl group-containing aromatic polyamide resin having a structure represented by the following formula (2):

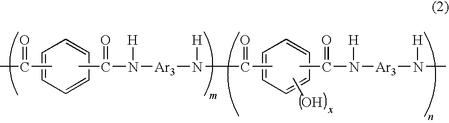

in the formula (2), m, n, x and Ar₃ are the same as the defined above.

The number of repeat units is preferably 10 to 1000. When the number of repeat units is smaller than 10, it becomes difficult to provide heat resistance that a phenolic hydroxyl group-containing aromatic polyamide resin inherently has and to produce the effect of a phenolic hydroxyl group. In addition, the surface of a copper foil is easily affected by a terminal group (an amino group or a carboxyl group) of the resin. In contrast, when the number of repeat units is larger than 1000, the viscosity of its solution is high. As a result, it becomes difficult to form a layer and adhesiveness with the surface of a copper foil decreases. In consideration of these drawbacks, the number of repeat units is preferably from 50 to 500. Furthermore, the weight-average molecular weight of the phenolic hydroxyl group-containing aromatic polyamide resin is preferably about 5,000 to 500,000 in view of workability.

Examples of the —Ar₃— group in the repeat structures of the formulas (1) and (2) and in the formula (4) preferably include one or more type of aromatic residues represented by the following formula (5):

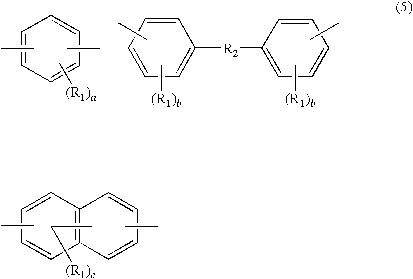

in the formula (5), R₁ is hydrogen or a substituent having 0 to 6 carbon atoms and optionally containing O, S, P, F, and/or Si; R₂ is a direct bond or a bond having 0 to 6 carbon atoms and optionally containing O, N, S, P, F, and/or Si; and a, b and c is average numbers of substituents and a and b each represent 0 to 4 and c represents 0 to 6.

Of them, an aromatic residue represented by the following formula (3) is preferable.

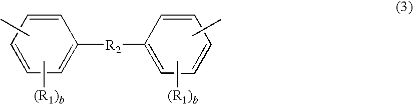

in the formula (3), R₁, R₂ and b are the same as the defined above.

In the formulas (3) and (5), preferable examples of R₁ may include a hydrogen atom; a hydroxyl group; chain alkyl groups such as a methyl group, an ethyl group, a propyl group, a butyl group, a pentyl group and a hexyl group; and cycloalkyl groups such as a cyclobutyl group, a cyclopentyl group and a cyclohexyl group. These may be the same or different; however, all may be preferably the same. Furthermore, in the formula (3), preferable examples of R₂ include direct bond, —O—, —SO₂—, —CO—, —(CH₂)₁₋₆—, —C(CH₃)₂— and —C(CF₃)₂—.

The phenolic hydroxyl group-containing aromatic polyamide resin in the present invention can be generally obtained by subjecting a phenolic hydroxyl group-containing dicarboxylic acid, optionally, another aromatic dicarboxylic acid, and an aromatic diamine to a condensation reaction using a condensing agent. When an elastomer structure is introduced into the phenolic hydroxyl group-containing aromatic polyamide resin, it can be introduced by reacting a polyamide resin (obtained after the condensation reaction) having a carboxylic acid at both ends or an amine at both ends with an elastomer having an amine at both ends or carboxylic acid at both ends.

The phenolic hydroxyl group-containing aromatic polyamide resin in the present invention may be synthesized by use of a method, for example, described in Japanese Patent No. 2969585. To explain more specifically, the polyamide resin can be obtained by performing a polycondensation reaction of an aromatic diamine component, an aromatic dicarboxylic acid component having a phenolic hydroxyl group and an aromatic dicarboxylic acid having no phenolic hydroxyl group in the presence of a phosphorous acid ester and a pyridine derivative. According to the aforementioned production method, a straight-chain aromatic polyamide copolymer can be easily produced without protecting a functional phenolic hydroxyl group and without entailing a reaction of the phenolic hydroxyl group with other reactive group such as a carboxyl group or an amino group. In addition, this method is advantageous since high temperature conditions are not required for the polycondensation reaction, that is, the polycondensation reaction can be performed at about 150° C. or less.

Next, a method for producing a phenolic hydroxyl group-containing aromatic polyamide resin according to the present invention will be more specifically described below. Examples of the aromatic diamine for use in producing a phenolic hydroxyl group-containing aromatic polyamide resin include

phenylenediamine derivatives such as m-phenylenediamine, p-phenylenediamine and m-tolylenediamine;

diaminodiphenyl ether derivatives such as 4,4′-diaminodiphenyl ether, 3,3′-dimethyl-4,4′-diaminodiphenyl ether and 3,4′-diaminodiphenyl ether;

diaminodiphenyl thioether derivatives such as 4,4′-diaminodiphenyl thioether, 3,3′-dimethyl-4,4′-diaminodiphenyl thioether, 3,3′-diethoxy-4,4′-diaminodiphenyl thioether, 3,3′-diaminodiphenyl thioether and 3,3′-dimethoxy-4,4′-diaminodiphenyl thioether;

diaminobenzophenone derivatives such as 4,4′-diaminobenzophenone and 3,3′-dimethyl-4,4′-diaminobenzophenone;

diaminodiphenylsulfone derivatives such as 4,4′-diaminodiphenyl sulfoxide and 4,4′-diaminodiphenylsulfone;

benzidine;

benzidine derivatives such as, 3,3′-dimethylbenzidine, 3,3′-dimethoxybenzidine and 3,3′-diaminobiphenyl;

xylylenediamine derivatives such as p-xylylenediamine, m-xylylenediamine and o-xylylenediamine; and

diaminodiphenylmethane derivatives such as 4,4′-diaminodiphenylmethane, 3,3′-diaminodiphenylmethane, 4,4′-diamino-3,3′-dimethyldiphenylmethane, 4,4′-diamino-3,3′-diethyldiphenylmethane, 4,4′-diamino-3,3′,5,5′-tetramethyldiphenylmethane, and 4,4′-diamino-3,3′,5,5′-tetraethyldiphenylmethane.

A diaminodiphenyl ether derivative or a diaminodiphenylsulfone derivative is preferable.

The aromatic dicarboxylic acid having a phenolic hydroxyl group is not particularly limited as long as the aromatic dicarboxylic acid has a structure having an aromatic ring and a single carboxyl group and one or more hydroxyl groups. Examples thereof include a dicarboxylic acid having a single hydroxyl group and two carboxyl groups on a benzene ring, such as 5-hydroxyisophthalic acid, 4-hydroxyisophthalic acid, 2-hydroxyisophthalic acid, 3-hydroxyisophthalic acid, or 2-hydroxyterephthalicacid. In view of solubility of the resultant polymer in a solvent, purity thereof, electric properties of the resultant epoxy resin composition, and adhesiveness to metal foil and polyimide, etc., 5-hydroxyisophthalic acid is preferable. The phenolic hydroxyl group-containing aromatic dicarboxylic acid is used in a rate of 0.5% by mole or more and less than 5% by mole of the total amount of carboxylic acid components. A value of n/(n+m) in the formula (1) is determined by the charge ratio.

Examples of the aromatic dicarboxylic acid having no phenolic hydroxyl group include phthalic acid, isophthalic acid, terephthalic acid, 4,4′-oxydibenzoic acid, 4,4′-biphenyldicarboxylic acid, 3,3′-methylenedibenzoic acid, 4,4′-methylenedibenzoic acid, 4,4′-thiodibenzoic acid, 3,3′-carbonyldibenzoic acid, 4,4′-carbonyldibenzoic acid, 4,4′-sulfonyldibenzoic acid, 1,5-naphthalenedicarboxylic acid, 1,4-naphthalenedicarboxylic acid, 2,6-naphthalenedicarboxylic acid and 1,2-naphthalenedicarboxylic acid. Isophthalic acid is preferable.

Examples of the phosphorous acid ester include, but are not limited to, triphenyl phosphite, diphenyl phosphite, tri-o-tolyl phosphite, di-o-tolyl phosphite, tri-m-tolyl phosphite, tri-p-tolyl phosphite, di-p-tolyl phosphite, di-p-chlorophenyl phosphite and tri-p-chlorophenyl phosphite.

Examples of the pyridine derivative to be used in combination with the phosphorous acid ester include pyridine, 2-picoline, 3-picoline, 4-picoline and 2,4-lutidine.

The condensing agent to be used in production of the phenolic hydroxyl group-containing aromatic polyamide resin to be used in the present invention includes the phosphorous acid ester and the pyridine derivative as mentioned above. The pyridine derivative is generally added to an organic solvent and put in use. The organic solvent desirably has no substantial reactivity with the phosphorous acid ester and has a property of satisfactorily dissolving the aromatic diamine and the dicarboxylic acids as mentioned above, and additionally, is a good solvent for a reaction product, that is, a phenolic hydroxyl group-containing aromatic polyamide resin. Examples of the organic solvent satisfying these conditions include amide solvents such as N-methylpyrrolidone and dimethylacetamide, toluene, MEK and a solvent mixture of these and an amide solvent. Of them, N-methyl-2-pyrrolidone is preferable. Generally, a mixture of a pyridine derivative and a solvent containing the pyridine derivative in an amount of 5 to 30% by weight of the mixture is used.

To obtain a phenolic hydroxyl group-containing aromatic polyamide resin having a high degree of polymerization, an inorganic salt or salts such as lithium chloride or calcium chloride are preferably added other than the phosphorous acid ester and the pyridine derivative as mentioned above.

Next, the method for producing a phenolic hydroxyl group-containing aromatic polyamide resin according to the present invention will be described more specifically below. First, a phosphorous acid ester is added to a solvent mixture containing an organic solvent and a pyridine derivative. To this, an aromatic dicarboxylic acid having a phenolic hydroxyl group, an aromatic dicarboxylic acid having no phenolic hydroxyl group, and an aromatic diamine (in an amount of 50 to 200 moles based on 100 moles of the total amount of the dicarboxylic acids mentioned above) are added. Subsequently, the mixture is stirred with heating under the atmosphere of an inactive gas such as nitrogen. After completion of the reaction, a poor solvent such as water, methanol or hexane is added to the reaction solution or the reaction solution is added to the poor solvent. After the produced polymer is separated in this way, purification is performed by a reprecipitation method to remove side products and inorganic salts. In this manner, the phenolic hydroxyl group-containing aromatic polyamide resin represented by the formula (1) above can be obtained.

The addition amount of a phosphorous acid ester serving as a condensing agent in the aforementioned production method is generally an equivalent mole or more relative to that of a carboxyl group. However, an amount of 30 fold or more is not efficient. Furthermore, when a phosphorous acid triester is used, a phosphorous acid diester is produced as a side product, which also serves as a condensing agent. Therefore, the amount of phosphorous acid triester may be about 80% by mole of the amount generally used. The amount of a pyridine derivative must be an equimolar or more relative to the amount of a carboxyl group. However, in practice, the pyridine derivative is often used excessively since it is also used as a reaction solvent. The use amount of a mixture of the pyridine derivative as mentioned above and an organic solvent preferably falls within the range of 5 to 30 parts by weight relative to 100 parts by weight of the theoretical amount of phenolic hydroxyl group-containing aromatic polyamide resin. The reaction temperature is generally preferably 60 to 180° C. The reaction time, which greatly varies depending upon the reaction temperature, is, in all cases, the period of time required for stirring the reaction system until a maximum viscosity (representing a maximum degree of polymerization) is obtained, generally from several minutes to 20 hours. When the dicarboxylic acids and the diamine are used in equal moles and reacted under preferable conditions, a phenolic hydroxyl group-containing aromatic polyamide resin having the most preferable average polymerization degree (about 2 to 100) can be obtained.

The phenolic hydroxyl group-containing aromatic polyamide resin having a preferable average polymerization degree has an intrinsic viscosity within the range of 0.1 to 4.0 dl/g as measured in 0.5 g/dl of N,N-dimethylacetamide solution at 30° C. In general, whether the aromatic polyamide resin has a preferable average polymerization degree or not can be determined with reference to the intrinsic viscosity. When the intrinsic viscosity is smaller than 0.1 dl/g, film-formability and the properties of the aromatic polyamide resin cannot be sufficiently expressed, and thus not preferable. Conversely, when the intrinsic viscosity is larger than 4.0 dl/g, the degree of polymerization becomes too high, with the result that solubility of the resin in a solvent and moldability/processability thereof deteriorate.

As a simple method for controlling the degree of polymerization of a phenolic hydroxyl group-containing aromatic polyamide resin, a method may be used in which either one of an aromatic diamine or aromatic dicarboxylic acids is added excessively.

The resin layer to be used in the present invention contains a phenolic hydroxyl group-containing aromatic polyamide and optionally an aromatic epoxy resin. The aromatic epoxy resin to be used is not particularly limited as long as it has an aromatic ring such as a benzene ring, a biphenyl ring or a naphthalene ring and two or more epoxy groups in a single molecule. Specific examples thereof include, but are not limited to, a novolak epoxy resin, a xylylene skeleton-containing phenol novolak epoxy resin, a biphenyl skeleton-including novolak epoxy resin, a bisphenol A epoxy resin, a bisphenol F epoxy resin and a tetramethylbiphenyl epoxy resin.

When the resin layer in the present invention contains an aromatic epoxy resin, a phenolic hydroxyl group-containing aromatic polyamide resin serves as a hardening agent for the epoxy resin. Further in this case, another type of hardening agent may be used in combination the phenolic hydroxyl group-containing polyamide resin. Specific examples of the hardening agent used in combination include, but are not limited to, polyamide resins, which are synthesized by a dimer of diaminodiphenylmethane, diethylenetriamine, triethylenetetramine, diaminodiphenylsulfone, isophoronediamine, dicyandiamide or linolenic acid, and ethylenediamine; phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, methylhexahydrophthalic anhydride, phenol novolak, triphenylmethane and modified compounds of these; imidazoles, BF₃-amine complexes and guanidine derivatives. When these are used in combination, the rate of a phenolic hydroxyl group-containing aromatic polyamide resin in the resin layer is generally 50% by weight or more, and preferably 80% by weight or more. When the rate of the phenolic hydroxyl group-containing aromatic polyamide resin is less than 50% by weight, flexibility and flame resistance of the resultant resin layer are rarely ensured.

The total use amount of the hardening agent(s) including the phenolic hydroxyl group-containing aromatic polyamide resin is preferably 0.7 to 1.2 equivalents in terms of active hydrogen relative to one equivalent of an epoxy group of the aromatic epoxy resin. When the use amount is less than 0.7 equivalents in terms of active hydrogen relative to one equivalent of an epoxy group or when the use amount exceeds 1.2 equivalents in terms of active hydrogen, complete hardening may not be performed, and good hardening properties may not be obtained. The equivalent in terms of active hydrogen of the phenolic hydroxyl group-containing aromatic polyamide resin represented by the formula (1) can be calculated from the total of the amount of an aromatic dicarboxylic acid having a phenolic hydroxyl group supplied at the time of reaction and the amount of aromatic diamine excessively supplied.

Furthermore, the hardening agent may be used in combination with a hardening accelerator. Specific examples of the hardening accelerator that can be used include imidazoles such as 2-methylimidazole, 2-ethylimidazole, 2-ethyl-4-methylimidazole, 2-phenyl-4,5-dihydroxymethylimidazole and 2-phenyl-4-methyl-5-hydroxymethylimidazole; tertiary amines such as 2-(dimethylaminomethyl)phenol and 1,8-diazabicyclo(5,4,0)undecene-7; phosphines such as triphenylphosphine; and metal compounds such as tin octylate. The hardening accelerator may be used in an amount of 0.1 to 5.0 parts by weight relative to 100 parts by weight of an aromatic epoxy resin, as needed.

To the resin layer in the present invention, various types of additives may be added unless they affect the adhesive strength between the resultant resin layer and the copper foil having no roughening treatment applied thereto and unless they affect the rust-preventing effect for the copper foil. Examples of the additives include an inorganic filler such as silica, calcium carbonate, calcium phosphate, magnesium hydroxide, aluminum hydroxide, alumina, talc or short glass fiber; a mold-release agent such as a polyimide precursor, a ring-closed polyimide resin, a silane coupling agent, stearic acid, palmitic acid, zinc stearate or calcium stearate; a pigment, a dye, a halation inhibitor, a fluorescent whitening agent, a surfactant, a leveling agent, a plasticizer, a flame retardant, an antioxidant, a filler, an antistatic agent, a viscosity modifier, an imidization catalyst, an accelerator, a dehydrating agent, an imidization retarder, a photostabilizer, a photocatalyst, a low dielectric substance, a conductive substance, a magnetic substance and a pyrolytic compound. The amount of additives in the resin layer is preferably 0 to 30% by weight.

The resin layer in the present invention can be obtained by dissolving or optionally partly dispersing a phenolic hydroxyl group-containing aromatic polyamide resin, and optionally, an aromatic epoxy resin, a hardening agent and additives, and hardening the resultant resin solution by drying or optionally heating. Examples of the solvent to be used in the resin solution include

γ-butyrolactones;

amide solvents such as N-methylpyrrolidone (NMP), N,N-dimethylformamide (DMF), N,N-dimethylacetamide and N,N-dimethylimidazolidinone;

sulfones such as tetramethylenesulfone;

ether solvents such as diethylene glycol dimethyl ether, diethylene glycol diethyl ether, propylene glycol, propylene glycol monomethyl ether, propylene glycol monomethyl ether monoacetate and propylene glycol monobutyl ether;

ketones solvents such as methyl ethyl ketone, methyl isobutyl ketone, cyclopentanone and cyclohexanone; and

aromatic solvents such as toluene and xylene.

The concentration of solid-matter (a phenolic hydroxyl group-containing aromatic polyamide resin, optionally an aromatic epoxy resin, a hardening agent and additives) in the obtained resin solution is generally 10 to 80% by weight, and preferably 20 to 70% by weight.

When a conventional polyimide resin is processed into a film, generally a vanish containing a precursor of the resin is applied onto a substrate, dried and heated to a high temperature of 300° C. or more. In this manner, a ring closure reaction of the precursor is performed. In contrast, the resin layer in the present invention can be obtained by applying the resin solution containing a phenolic hydroxyl group-containing aromatic polyamide resin as a main component directly onto a copper foil having no roughening treatment applied thereto, subjecting the copper foil to a drying step of 250° C. or less, and optionally, to a subsequent hardening step. It is satisfactory that the thickness of the coating film, in terms of the thickness of a resin layer, is 1 to 100 μm. About a 40 μm-thick resin layer can be obtained by applying a 40 wt % resin solution to obtain a thickness of 100 μm and drying the coating film at 80 to 200° C. for 5 to 60 minutes, and preferably 130 to 150° C. for 10 to 30 minutes. If hardening is required, further a heat treatment is conducted at 150 to 250° C. for 30 minutes to 2 hours after the drying. In this manner, the copper foil with a resin layer of the present invention can be obtained.

As a heat source for use in drying and hardening step, hot air or a far-infrared heater may be used; however, hot air is favorably used in combination with a far-infrared heater to prevent solvent vapor from retaining and transmit heat into the inner portion of the resin.

As a copper foil used as the copper foil with a resin layer of the present invention, any copper foil having no roughening treatment applied thereto may be used, more specifically, an electrolytic copper foil or a rolled copper foil may be used. Alternatively, a copper foil having a plating layer formed of one or more types of metals selected from nickel, iron, zinc, gold and tin, and/or a copper foil having a layer of a silane coupling agent can be used. The surface roughness (Rz) of these foils is generally 2 μm or less.

The plating layer provided, as needed, on the surface of a copper foil is formed by electrolytic or non-electrolytic plating performed in a solution containing one or more types of ionized metals selected from nickel, iron, zinc, gold and tin. The thickness of the plating layer is preferably 10 to 300 nm.

As the silane coupling agent, various types of commercially available silane coupling agents (for example, KBM series manufactured by Shin-Etsu Chemical Co., Ltd.) other than amino- and epoxy-coupling agents. The thickness of the silane coupling layer is preferably 1 to 50 nm.

### EXAMPLES

The present invention will be more specifically described below by way of examples; however the present invention is not limited to these examples.

The properties of a film are determined by the following methods.

### (Measurement of Adhesive Strength to Copper Foil)

On a copper foil having no roughening treatment applied thereto (or a copper foil having a metal plating layer formed thereon), a resin layer containing a phenolic hydroxyl group-containing aromatic polyamide resin was applied to a predetermined thickness and dried. Onto the copper foil of the resultant film with a copper foil on one surface, a pattern having a width of 3 mm was formed via a mask. The film side thereof was bonded to an iron board of 0.3×70×150 mm (Can Super, manufactured by Paltec) with a bonding sheet. The edge of the copper foil having a width of 3 mm was removed from the resin by a cutter knife. The adhesive strength between the copper foil and the resin was measured in the direction of 180° C. by using a tensilon tester (A and D manufactured by Orientec Co., Ltd.) on the basis of JIS C5471.

### (Flammability Test)

The resin layer alone was tested for flammability on the basis of UL94.

### Synthesis Example 1

A flask equipped with a thermometer, a cooling pipe and a stirrer was purged with nitrogen gas. 0.49 g of 5-Hydroxyisophthalic acid (2.69 mmol), 21.86 g of isophthalic acid (131.7 mmol), 27.42 g of 3,4′-diaminodiphenyl ether (137.1 mmol), 1.43 g of lithium chloride, 148.35 g of N-methylpyrrolidone and 31.72 g of pyridine were placed in the flask, and the solid matter was dissolved by stirring. Thereafter, 68.74 g of triphenyl phosphite was added thereto and the mixture was allowed to react at 90° C. for 8 hours to obtain a reaction solution containing a phenolic hydroxyl group-containing aromatic polyamide resin (A) having a structure represented by the following formula (6):

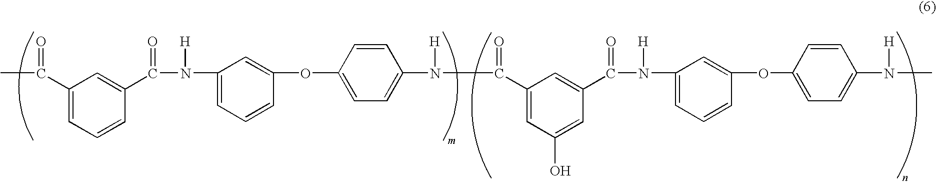

in the formula (6), n/(m+n)=0.02.

After the reaction solution was cooled down to room temperature, methanol (500 g) was added thereto. The precipitated resin was collected by filtration and purified by washing five times with ionized water (700 g) and with methanol (500 g) under reflux. After that, filtration was performed and the filtrate was dried to obtain resin powder (A) in an amount of 43.5 g and a yield of 96.8%. 0.100 g of The resin powder (A) was dissolved in 20.0 ml of N,N-dimethylacetamide. The viscosity (in terms of log) measured by an Ostwald viscosimeter at 30° C. was 0.50 dl/g. The active-hydrogen equivalent to an epoxy group was calculated, and was 5,577 g/eq. The weight-average molecular weight (Mw) and number-average molecular weight (Mn) measured by GPC (gel permeation chromatography) in terms of styrene were 106,000 and 44,000, respectively.

### Synthesis Example 2

The same process as in Synthesis Example 1 was repeated except that 27.42 g of 3,4′-diaminodiphenyl ether of Synthesis Example 1 was replaced by 27.42 g of 4,4′-diaminodiphenyl ether to obtain a reaction solution containing a phenolic hydroxyl group-containing aromatic polyamide resin (B) having a structure represented by the following formula (7):

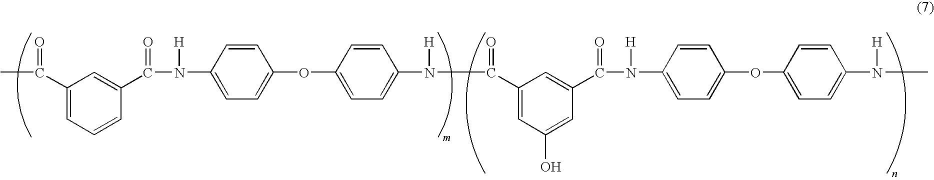

in the formula (7), n/(m+n)=0.02.

Then, a resin powder (B) was obtained in an amount of 44.0 g and a yield of 97.9%. 0.100 g of The resin powder (B) was dissolved in 20.0 ml of N,N-dimethylacetamide. The viscosity (in terms of log) measured by an Ostwald viscosimeter at 30° C. was 0.65 dl/g. The active-hydrogen equivalent to an epoxy group was calculated, and was 5,577 g/eq. The weight-average molecular weight (Mw) and number-average molecular weight (Mn) measured by GPC in terms of styrene were 146,800 and 52,000, respectively.

### Synthesis Example 3

The same process as in Synthesis Example 1 was repeated except that 27.42 g of 3,4′-diaminodiphenyl ether of Synthesis Example 1 was replaced by 30.03 g of 3,3′-diaminodiphenylsulfone (121.1 mmol), and that the amount of 5-hydroxyisophthalic acid was changed to 0.43 g (0.36 mmol) and that the amount of isophthalic acid was changed to 19.30 g (116.3 mmol) to obtain a reaction solution containing a phenolic hydroxyl group-containing aromatic polyamide resin (C) having a structure represented by the following formula (8):

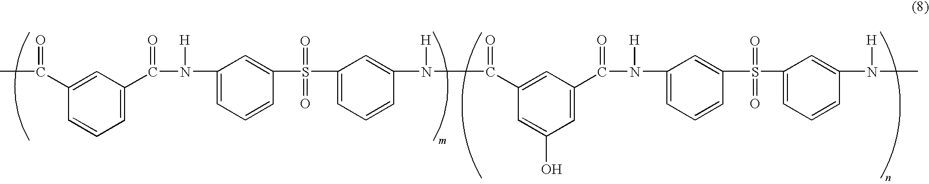

in the formula (8), n/(m+n)=0.02.

Then, a resin powder (C) was obtained in an amount of 44.5 g and a yield of 97.8%. 0.100 g of The resin powder (C) was dissolved in 20.0 ml of N,N-dimethylacetamide. The viscosity (in terms of log) measured by an Ostwald viscosimeter at 30° C. was 0.52 dl/g. The active-hydrogen equivalent to an epoxy group was calculated, and was 6,499 g/eq. The weight-average molecular weight (Mw) and number-average molecular weight (Mn) measured by GPC in terms of styrene were 41,700 and 12,100, respectively.

### Synthesis Example 4

The same process as in Synthesis Example 3 was repeated except that 30.03 g of 3,3′-diaminodiphenylsulfone of Synthesis Example 3 was replaced with 30.03 g of 4,4′-diaminodiphenylsulfone to obtain a reaction solution containing a phenolic hydroxyl group-containing aromatic polyamide resin (D) having a structure represented by the following formula (9):

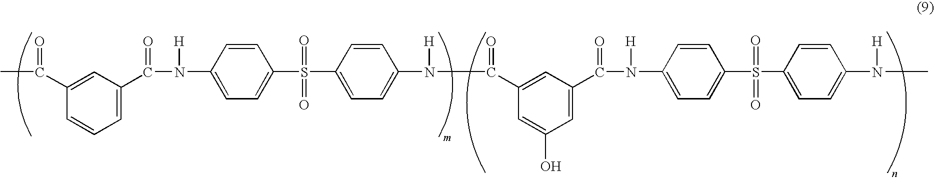

in the formula (8), n/(m+n)=0.02.

Then, a resin powder (D) was obtained in an amount of 43.0 g and a yield of 94.5%. 0.100 g of The resin powder (D) was dissolved in 20.0 ml of N,N-dimethylacetamide. The viscosity (in terms of log) measured by an Ostwald viscosimeter at 30° C. was 0.60 dl/g. The active-hydrogen equivalent to an epoxy group was calculated, and was 6,499 g/eq. The weight-average molecular weight (Mw) and number-average molecular weight (Mn) measured by GPC in terms of styrene were 16,300 and 6,500, respectively.

### Synthetic Example 5

The same process as in Synthesis Example 1 was repeated except that 27.42 g of 3,4′-diaminodiphenyl ether of Synthesis Example 1 was replaced by 27.30 g of 4,4′-diaminodiphenylmethane (137.9 mmol), and that the amount of isophthalic acid was changed to 21.97 g (132.3 mmol) to obtain a reaction solution containing a phenolic hydroxyl group-containing aromatic polyamide resin (E) having a structure represented by the following formula (10):

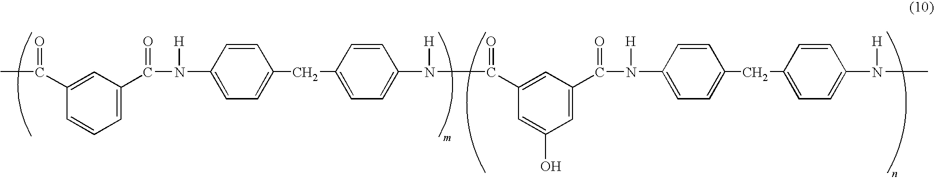

in the formula (10), n/(m+n)=0.02.

Then, a resin powder (E) was obtained in an amount of 44.0 g and a yield of 98.0%. 0.100 g of The resin powder (E) was dissolved in 20.0 ml of N,N-dimethylacetamide. The viscosity (in terms of log) measured by an Ostwald viscosimeter at 30° C. was 0.50 dl/g. The active-hydrogen equivalent to an epoxy group was calculated, and was 5,544 g/eq. The weight-average molecular weight (Mw) and number-average molecular weight (Mn) measured by GPC in terms of styrene were 143,000 and 43,300, respectively.

### Examples 1 to 5

The resins (A) to (E) obtained in synthesis Examples 1 to 5 each were dissolved in a solvent to obtain coating solutions (a) to (e). Each of the coating solutions thus obtained was applied onto a rolled copper foil having a thickness of 17 μm and a surface roughness (Rz) of 2 μm or less by use of an automatic applicator (manufactured by Yasuda Seiki Seisaku-sho). Thereafter, the resultant coating, was dried at 130° C. for 10 minutes to obtain a copper foil with a resin layer according to the present invention. The compositions of the coating solutions are shown in Table 1. The rust-preventing effect of copper foils with a resin layer and the physical properties of resins are shown in Table 2. In the column of Tg of Table 2 representing heat resistance, tan δ peak temperature is shown when the resin layer remaining after removal of a copper foil by etching from the copper foil with a resin layer was measured by DMA. In the column of flame resistance, the results of the flammability test of the resin layer are shown. The adhesive strength between a copper foil and a polyimide resin was determined by further forming a polyimide resin film, which was obtained by applying, onto the copper foil with a resin layer, KAYAFLEX KPI (polyimide precursor solution manufactured by Nippon Kayaku Co., Ltd.) having a polyimide precursor represented by the following formula (11) dissolved in a solvent mixture of N-methyl-2-pyrrolidone and N,N-dimethylacetamide, to a predetermined thickness, drying and heating the film, and performing a ring closure reaction.

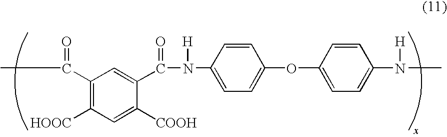

in the formula (11), x represents the number of repeats; and the weight-average molecular weight of the whole molecule is 81,000. The results are shown in the column of adhesive strength of Table 2. The thickness of the phenolic hydroxyl group-containing aromatic polyamide resin is shown in the column of resin film thickness of Table 2. Furthermore, the total thickness of the polyimide resin layer and the phenolic hydroxyl group-containing aromatic polyamide resin layer is shown in the column of thickness of resin for adhesive strength measurement. The rust-preventing effect was evaluated by observing the difference between the surface state of the copper foil with a resin layer according to the present invention immediately after being exposed to air and that after being exposed continuously for a week.

### Comparative Example 1

A rolled copper foil having a thickness of 17 μm and a surface roughness (Rz) of 2 μm or less was exposed to air with no resin layer formed thereon. The rust-preventing effect was evaluated by observing the difference between the surface state thereof between immediately after being exposed to air and that after being exposed continuously for a week and is shown in Table 2.

TABLE 1

| | Example 1 | Example 3 | Example 3 | Example 4 | Example 5 |
|---|---|---|---|---|---|
| Resin | Synthesis | Synthesis | Synthesis | Synthesis | Synthesis |
| | Example 1 | Example 2 | Example 3 | Example 4 | Example 5 |
| Solvent | DMF | NMP | NMP | NMP | NMP |
| Concen- | 38% by | 20% by | 30% by | 40% by | 20% by |
| tration of | weight | weight | weight | weight | weight |
| resin content | | | | | |

TABLE 2

| | | | | | | Comparative |
|---|---|---|---|---|---|---|
| Resin | Example 1 | Example 2 | Example 3 | Example 4 | Example 5 | Example 1 |
| Thickness of resin | 5 μm | 5 μm | 4 μm | 5 μm | 6 μm | — |
| Surface of copper | Not treated | Not treated | Not treated | Not treated | Not treated | Not treated |
| foil | Rz < 2 μm | Rz < 2 μm | Rz < 2 μm | Rz < 2 μm | Rz < 2 μm | Rz < 2 μm |
| Tg | 250° C. | 300° C. | 180° C. | 280° C. | 350° C. | — |
| Thickness of resin | 23 μm | 25 μm | 28 μm | 20 μm | 27 μm | 0 μm |
| for adhesive strength | | | | | | |
| measurement | | | | | | |
| Adhesive strength | 1.2 N/mm | 1.1 N/mm | 0.9 N/mm | 1.4 N/mm | 1.0 N/mm | — |
| Flame resistance | V-0 | V-0 | V-0 | V-0 | V-0 | — |
| Difference of the | Not | Not | Not | Not | Not | Generation of |
| surface of copper foil | changed | changed | changed | changed | changed | rust spots |
| immediately after | | | | | | |
| exposure and that | | | | | | |
| after a week | | | | | | |
| exposure | | | | | | |

### Examples 6 to 10

The resins (A) to (E) obtained in Synthesis Examples 1 to 5 each were dissolved in a solvent. An aromatic epoxy resin, a hardening agent and a hardening accelerator were blended with the resultant solution to obtain coating solutions (a′) to (e′). Each of the coating solutions thus obtained was applied onto a rolled copper foil having a thickness of 17 μm and a surface roughness (Rz) of 2 μm or less by use of an automatic applicator (manufactured by Yasuda Seiki Seisaku-sho) and the resultant coating was dried at 130° C. for 10 minutes to obtain a copper foil with a resin layer according to the present invention. The compositions of the coating solutions are shown in Table 3. The epoxy resin of Table 3 was an aromatic epoxy resin: NC-3000 (epoxy equivalent: 265 to 285 g/eq, manufactured by Nippon Kayaku Co., Ltd.). As the hardening agent, Kaya Hard GPH-65 (active-hydrogen equivalent: 200 to 205 g/eq, manufactured by Nippon Kayaku Co., Ltd.) was used. As the hardening accelerator, 2MZ (2-methylimidazole, manufactured by Shikoku Chemicals Corporation) was used. The rust-preventing effects of copper foils with a resin layer and the physical properties of resins are shown in Table 4. In the column of Tg of Table 4 representing heat resistance, tan δ peak temperature is shown when the resin layer remaining after removal of a copper foil by etching from the copper foil with a resin layer was measured by DMA. In the column of flame resistance, the results of the flammability test of the resin layer are shown. In the column of flame resistance, the results of the flammability test of the resin layer are shown. The thickness of the resin layer of the copper foil with a resin layer is shown in the column of resin thickness of Table 4. Moreover, the adhesive strength between the copper foil and the resin layer is shown in the column of adhesive strength. The rust-preventing effect was evaluated by observing the difference between the surface state of a copper foil with a resin layer according to the present invention immediately after being exposed to air and that after being exposed continuously for a week.

### Comparative Example 2

KAYAFLEX KPI (polyimide precursor solution manufactured by Nippon Kayaku Co., Ltd.) having a polyimide precursor represented by the formula (11) above dissolved in a solvent mixture of N-methyl-2-pyrrolidone and N,N-dimethylacetamide was applied onto a rolled copper foil having a thickness of 17 μm and a surface roughness (Rz) of 2 μm or less, and the coating was dried and heated, and a ring closure reaction was performed to obtain a copper foil with a polyimide resin layer. The rust-preventing effect of the copper foil with a resin layer and the physical properties of the resin are shown in Table 4. In the column of Tg of Table 4 representing heat resistance, tan δ peak temperature is shown when the resin layer remaining after removal of a copper foil by etching from the copper foil with a resin layer was measured by DMA. In the column of flame resistance, the results of the flammability test of the resin layer are shown. The thickness of the resin layer of the copper foil with a resin layer is shown in the column of resin thickness of Table 4. The adhesive strength between the copper foil and the resin layer is shown in the column of adhesive strength. The rust-preventing effect was evaluated by observing the difference between the surface state of a copper foil with a resin layer immediately after being exposed to air and that after being exposed continuously for a week.

TABLE 3

| | Example 6 | Example 7 | Example 8 | Example 9 | Example 10 |
|---|---|---|---|---|---|
| Resin (parts by | Synthesis | Synthesis | Synthesis | Synthesis | Synthesis |
| weight) | Example 1 | Example 2 | Example 3 | Example 4 | Example 5 |
| | 100 | 100 | 100 | 100 | 100 |
| Epoxy resin (parts by | NC-3000 9 | NC-3000 9 | NC-3000 9 | NC-3000 9 | NC-3000 9 |
| weight) | | | | | |
| Hardening agent (parts | GPH-65 | GPH-65 | GPH-65 | GPH-65 | GPH-65 |
| by weight) | 2.5 | 2.5 | 2.5 | 2.5 | 2.5 |
| Hardening accelerator | 2MZ | 2MZ | 2MZ | 2MZ | 2MZ |
| (parts by weight) | 0.4 | 0.4 | 0.4 | 0.4 | 0.2 |
| Solvent | DMF | NMP | NMP | NMP | NMP |
| Solid-matter | 40% by | 22% by | 32% by | 42% by | 22% by |
| concentration | weight | weight | weight | weight | weight |

TABLE 4

| | | | | | | Comparative |
|---|---|---|---|---|---|---|
| Resin | Example 6 | Example 7 | Example 8 | Example 9 | Example 10 | Example 2 |
| Resin thickness | 23 μm | 27 μm | 25 μm | 26 μm | 24 μm | 20 μm |
| Surface of copper | Not treated | Not treated | Not treated | Not treated | Not treated | Not treated |
| foil | Rz < 2 μm | Rz < 2 μm | Rz < 2 μm | Rz < 2 μm | Rz < 2 μm | Rz < 2 μm |
| Tg | 245° C. | 298° C. | 170° C. | 268° C. | 320° C. | >350° C. |
| Adhesive strength | 1.5 N/mm | 1.4 N/mm | 1.1 N/mm | 1.3 N/mm | 1.4 N/mm | 0.3 N/mm |
| Flame resistance | V-0 | V-0 | V-0 | V-0 | V-0 | V-0 |
| Difference | Not changed | Not changed | Not changed | Not changed | Not changed | Generation of |
| between the | | | | | | rust spots on |
| surface of copper | | | | | | the whole |
| foil immediately | | | | | | surface |
| after exposure and | | | | | | |
| that after a week | | | | | | |
| exposure | | | | | | |

### Examples 11 to 15

A copper foil with a resin layer according to the present invention was obtained in the same manner as in Example 6 except that a rolled copper foil the same as that of Example 6 except that it had a plating layer of a predetermined thickness was used in place of the rolled copper foil having a thickness of 17 μm and a surface roughness (Rz) of 2 μm or less of Example 6. Physical properties including adhesive strength are shown in Table 5. In the column of resin thickness in Table 5, the thickness of the resin layer is shown. In the column of adhesive strength, the adhesive strength between the copper foil and the resin layer is indicated. The rust-preventing effect was evaluated by observing the difference between the surface state of a copper foil with a resin layer according to the present invention immediately after being exposed to air and that after being exposed continuously for a week. The results are also shown in Table 5.

TABLE 5

| | Example 11 | Example 12 | Example 13 | Example 14 | Example 15 |
|---|---|---|---|---|---|
| Resin | Example 6 | Example 6 | Example 6 | Example 6 | Example 6 |
| Resin thickness | 25 μm | 22 μm | 27 μm | 23 μm | 22 μm |
| Type of plating | Ni | Cr | Fe | Ag | Sn |
| Thickness of plating layer | 120 nm | 60 nm | 80 nm | 50 nm | 100 nm |
| Surface of plating layer | Rz < 2 μm | Rz < 2 μm | Rz < 2 μm | Rz < 2 μm | Rz < 2 μm |
| Adhesive strength | 1.8 N/mm | 1.0 N/mm | 0.8 N/mm | 2.1 N/mm | 1.6 N/mm |
| Difference between the | Not changed | Not changed | Not changed | Not changed | Not changed |
| surface of copper foil | | | | | |
| immediately after | | | | | |
| exposure and that after a | | | | | |
| week exposure | | | | | |

### INDUSTRIAL APPLICABILITY

As described above, a copper foil with a resin layer according to the present invention has excellent adhesiveness between the resin layer and the copper foil. In addition, the resin layer has flexibility, heat resistance, rust preventing effect and flame resistance. Therefore, it is demonstrated that the copper foil with a resin layer of the present invention is extremely useful as the material for a flexible printed wiring board.

1. A copper foil with a resin layer characterized in that a copper foil having no roughening treatment applied thereto is directly joined to a resin layer, which contains a phenolic hydroxyl group-containing aromatic polyamide resin having a structure represented by the following formula (1): 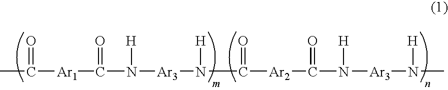
in the formula (1), m and n denote average values and satisfy the relationship:
005≦n/(m+n)<0.05,
m+n is 20 to 200; Ar₁ is a divalent aromatic group; Ar₂ is a divalent aromatic group having a phenolic hydroxyl group, and Ar₃ is a divalent aromatic group.

2. The copper foil with a resin layer according to claim 1, wherein the resin layer further contains an aromatic epoxy resin.

3. The copper foil with a resin layer according to claim 1 or 2, wherein the phenolic hydroxyl group-containing aromatic polyamide resin has a structure represented by the following formula (2): 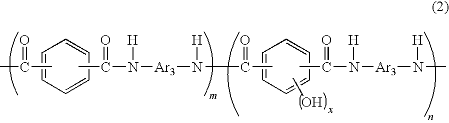
in the formula (2), n and m are defined the same as in the formula (1); x represents the average number of substituents from 1 to 4; and Ar₃ is represented by the following formula (3): 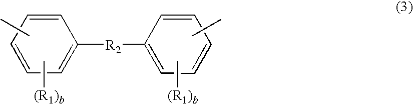
in the formula (3), R₁ is a hydrogen atom or a substituent having 0 to 6 carbon atoms and optionally containing O, S, P, F, and/or Si; R₂ is a direct bond or a bond which has 0 to 6 carbon atoms and which may optionally contain O, N, S, P, F, and/or Si; and b is the average number of substituents from 0 to 4.

4. The copper foil with a resin layer according to any one of claims 1 to 3, wherein the surface roughness (Rz) of the copper foil having no roughening treatment applied thereto is 2 μm or less.

5. A copper foil with a resin layer characterized in that a copper foil having no roughening treatment applied thereto and having a plating layer of one or more types of elements selected from nickel, iron, zinc, gold and tin on a surface thereof is directly joined to a resin layer containing a phenolic hydroxyl group-containing aromatic polyamide resin having a structure represented by the following formula (1): 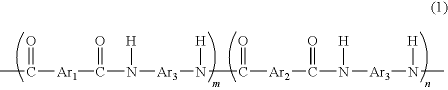
in the formula (1), m and n denote average values and satisfy the relationship:
0.005≦n/(m+n)<0.05,
m+n is 20 to 200; Ar₁ is a divalent aromatic group; Ar₂ is a divalent aromatic group having a phenolic hydroxyl group, and Ar₃ is a divalent aromatic group.

6. The copper foil with a resin layer according to any one of claims 1 to 5, wherein, in the formula (1), Ar₁ is a substituted or unsubstituted phenylene group; Ar₂ is a substituted or unsubstituted hydroxyphenylene group; and Ar₃ is an aromatic group formed by two substituted or unsubstituted phenyl groups bonded via —O— or —SO₂—.
